(19) United States
(12) Patent Application Publication
(10) Pub. No.: US 2014/0119079 A1
(43) Pub. Date: May 1, 2014

(54) POWER FACTOR CORRECTION CIRCUIT AND POWER SUPPLY DEVICE INCLUDING THE SAME

(71) Applicant: SAMSUNG ELECTRO-MECHANICS CO., LTD., Suwon (KR)

(72) Inventors: In Wha JEONG, Suwon (KR); Bum Seok SUH, Suwon (KR); Kwang Soo KIM, Suwon (KR); Hyo Jin LEE, Suwon (KR)

(73) Assignee: SAMSUNG ELECTRO-MECHANICS CO., LTD., Suwon (KR)

(21) Appl. No.: 13/740,796

(22) Filed: Jan. 14, 2013

(30) Foreign Application Priority Data
Oct. 31, 2012 (KR) 10-2012-0121981

(51) Int. Cl. G05F 1/70

(52) U.S. Cl. CPC G05F 1/70
USPC 363/89; 323/209

(57) ABSTRACT

There are provided an interleaved power factor correction circuit and a power supply device including the same, the power factor correction circuit including: a main switching unit including a first main switch and a second main switch; an auxiliary switching unit including a first auxiliary switch and a second auxiliary switch; an inductor unit positioned between an input power terminal to which the input power is applied and the main switching unit and storing or discharging power according to the switching operations of the main switching unit; and an auxiliary inductor adjusting an amount of current flowing in the auxiliary switching unit when the auxiliary switching unit performs switching operations.

### CROSS-REFERENCE TO RELATED APPLICATIONS

This application claims the priority of Korean Patent Application No. 10-2012-0121981 filed on Oct. 31, 2012, in the Korean Intellectual Property Office, the disclosure of which is incorporated herein by reference.

### BACKGROUND OF THE INVENTION

1. Field of the Invention

The present invention relates to an interleaved power factor correction circuit and a power supply device including the same.

2. Description of the Related Art

Recently, the governments of many countries have recommended the efficient use of energy according to energy efficiency policies, and in particular, the implementation of efficient energy usage in electronic products and home appliances is widely recommended.

In efficiently using energy according to such a governmental recommendation, a correction circuit for implementing efficient energy usage is largely applied to a power supply device that supplies power to electronic products, home appliances, and the like.

A power factor correction circuit is an example of the correction circuit. The power factor correction circuit is a circuit that switches input power to adjust a phase difference (power factor) between a current and a voltage of the input power in such a manner that power is effectively transferred to a rear stage.

Among power factor correction circuits, a boost power factor correction circuit is generally used, but it may be hard to apply to a power supply device having a medium or high capacity, due to a relatively low efficiency, a high internal current, a voltage ripple, electromagnetic interference (EMI) noise, and the like. In an effort to solve the defects of the boost power factor correction circuit, an interleaved boost power factor correction (PFC) circuit in which the conventional boost PFC circuits are connected in parallel has been proposed. In the interleaved PFC circuit, overall output power sources are uniformly operated in the respective boost PFC circuits with a time difference during a switching period, thereby reducing ripples in an input current and ripples in an output voltage. Thus, a size of an input EMI filter can be reduced. However, the interleaved boost PFC also switches input power, causing switching loss.

Patent Document 1 of the related art document relates to an interleaved PFC circuit and discloses extending a range of input power by controlling an operation of a second output transistor among first and second transistors that are interleave-connected to correct a power factor of the input power, but it does not disclose a reduction in switching loss.

### RELATED ART DOCUMENT

(Patent Document 1) U.S. Patent Laid Open Publication No. 2011/0199066

### SUMMARY OF THE INVENTION

An aspect of the present invention provides a power factor correction circuit capable of reducing switching loss generated during switching for power factor correction by transferring surplus power to a ground before performing the switching for power factor correction, and removing a peak voltage generated when the surplus power is transferred to the ground, and a power supply device including the same.

According to an aspect of the present invention, there is provided a power factor correction circuit including: a main switching unit including a first main switch and a second main switch performing switching operations with a phase difference of 180 degrees therebetween, in order to improve a power factor of input power; an auxiliary switching unit including a first auxiliary switch and a second auxiliary switch forming transmission paths for surplus power existing before the first main switch and the second main switch are turned on, respectively; an inductor unit positioned between an input power terminal to which the input power is applied and the main switching unit and storing or discharging power according to the switching operations of the main switching unit; and an auxiliary inductor adjusting an amount of current flowing in the auxiliary switching unit when the auxiliary switching unit performs switching operations.

The first auxiliary switch may perform a first switching operation of being turned on before the first main switch is turned on, and turned off before the first main switch is turned off, and the second auxiliary switch may perform a second switching operation of being turned on before the second main switch is turned on, and turned off before the second main switch is turned off.

The first switching operation and the second switching operation may have equal turn on intervals.

The power factor correction circuit may further include: a first backward current preventing diode and a second backward current preventing diode preventing backward currents in the first main switch and the second main switch, respectively.

The first auxiliary switch may perform a switching operation to form a transmission path for excessive power applied to the second auxiliary switch when the second switching operation is terminated, and the second auxiliary switch may perform a switching operation to form a transmission path for excessive power applied to the first auxiliary switch when the first switching operation is terminated.

The first auxiliary switch may perform the switching operation at a time at which the second switching operation is terminated, and the second auxiliary switch may perform the switching operation at a time at which the first switching operation is terminated.

The first auxiliary switch may be turned on during an interval identical to a turn on interval of the second switching operation at the time at which the second switching operation is terminated, and the second auxiliary switch may be turned on during an interval identical to a turn on interval of the first switching operation at the time at which the first switching operation is terminated.

The power factor correction circuit may further include: a diode unit providing transmission paths for the power discharged from the inductor unit according to the switching operations of the main switching unit.

The inductor unit may include: a first inductor connected between the input power terminal and the first main switch; and a second inductor connected between the input power terminal and the second main switch.

The diode unit may include: a first diode providing the transmission path for the power discharged from the first inductor according to the switching operation of the first main switch; and a second diode providing the transmission path for the power discharged from the second inductor according to the switching operation of the second main switch.

The power factor correction circuit may further include: a capacitor stabilizing the power transferred from the diode unit.

The power factor correction circuit may further include: a controller providing switching control signals for controlling the switching operations of the main switching unit and the auxiliary switching unit.

The input power may be rectified power.

According to another aspect of the present invention, there is provided a power supply device including: power factor correction circuit including a main switching unit including a first main switch and a second main switch performing switching operations with a phase difference of 180 degrees therebetween, in order to improve a power factor of input power; an auxiliary switching unit including a first auxiliary switch and a second auxiliary switch forming transmission paths for surplus power existing before the first main switch and the second main switch are turned on, respectively; an inductor unit positioned between an input power terminal to which the input power is applied and the main switching unit and storing or discharging power according to the switching operations of the main switching unit; and an auxiliary inductor adjusting an amount of current flowing in the auxiliary switching unit when the auxiliary switching unit performs switching operations; a power conversion unit switching the power from the power factor correction circuit to convert the power from the power factor correction circuit into power having a pre-set level; and a switching controller controlling the switching of the power performed by the power conversion unit.

The power supply device may further include a rectifying unit rectifying alternating current (AC) power to generate the input power, and transferring the input power to the power factor correction circuit.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are schematic circuit diagrams of a power factor correction circuit according to an embodiment of the present invention;

FIG. 3 is a graph showing switching control signals of a main switching unit and an auxiliary switching unit employed in the power factor correction circuit according to the embodiment of the present invention;

FIG. 4 is an enlarged view of portion A of the graph of FIG. 3;

FIG. 5A and FIG. 5B are graphs showing voltages generated from both ends of the auxiliary switching unit employed in the power factor correction circuit according to the embodiment of the present invention; and

FIG. 6 is a view schematically showing a configuration of a power supply device including a power factor correction circuit according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

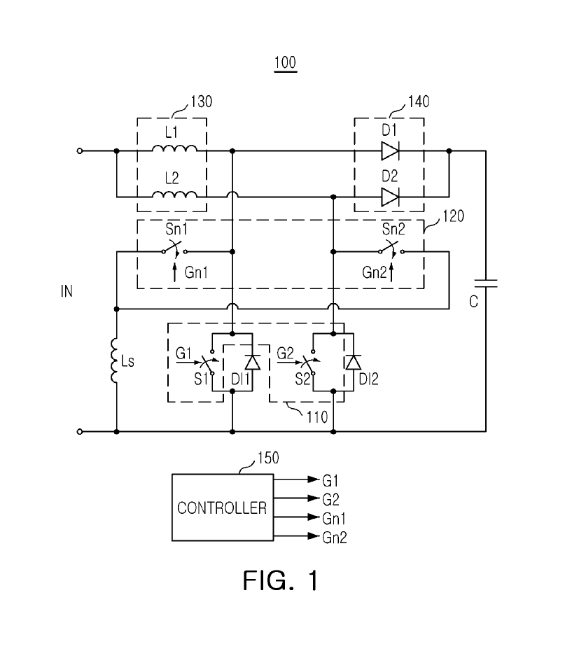

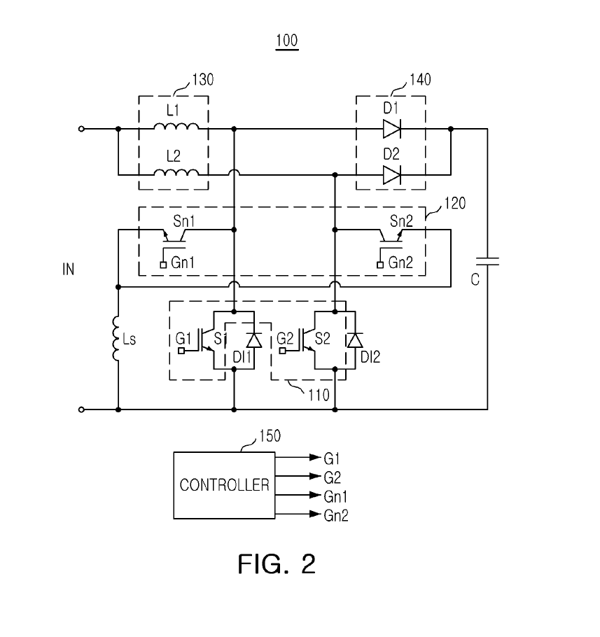

FIGS. 1 and 2 are schematic circuit diagrams of a power factor correction circuit according to an embodiment of the present invention.

Referring to FIG. 1, a power factor correction circuit 100 according to an embodiment of the present invention may include a main switching unit 110 and an auxiliary switching unit 120, and may further include first and second backward current preventing diodes DI1 and DI2, an inductor unit 130, an auxiliary inductor Ls, a diode unit 140, a capacitor C, and a controller 150.

In order to improve a power factor of input power, the main switching unit 110 may include a first main switch S1 and a second main switch S2 performing switching operations with a phase difference of 180 degrees therebetween. Here, the input power may be rectified power.

The first backward current preventing diode DI1 and the second backward current preventing diode DI2 may prevent backward currents in the first main switch S1 and the second main switch S2, respectively. When the first main switch S1 and the second main switch S2 are configured as transistors, the first backward current preventing diode DI1 and the second backward current preventing diode DI2 may be diodes formed in bodies of the transistors, but the present invention is not limited thereto and the first backward current preventing diode DI1 and the second backward current preventing diode DI2 may be separately added diodes.

The inductor unit 130 is connected between an input power terminal IN to which input power is applied and the main switching unit 110, and stores or discharges power according to switching of the main switching unit 110. In detail, the inductor unit 130 may include a first inductor L1 and a second inductor L2. The first inductor L1 may be connected between the input power terminal IN and the first main switch S1, and the second inductor L2 may be connected between the input power terminal IN and the second main switch S2.

The diode unit 140 may provide transmission paths for the power discharged from the inductor unit 130 according to the switching of the main switching unit 110. In detail, the diode unit 140 may include a first diode D1 and a second diode D2, and the first diode D1 may provide the transmission path for the power discharged from the first inductor L1 according to the switching operation of the first main switch S1 and the second diode D2 may provide the transmission path for the power discharged from the second inductor L2 according to the switching operation of the second main switch S2.

The capacitor C is connected to an output terminal in parallel to stabilize the power output from the diode unit 140.

The auxiliary switching unit 120 may include a first auxiliary switch Sn1 and a second auxiliary switch Sn2 connected to the first main switch S1 and the second main switch S2 in parallel, respectively.

The controller 150 may provide switching control signals G1, G2, Gn1, and Gn2 in order to control switching operations of the first main switch S1, the second main switch S2, the first auxiliary switch Sn1, and the second auxiliary switch Sn2.

Each of the first main switch S1, the second main switch S2, the first auxiliary switch Sn1, and the second auxiliary switch Sn2 according to the embodiment of the present invention may be an insulated gate bipolar transistor (IGBT), a metal oxide semiconductor field effect transistor (MOSFET), or a bipolar junction transistor (BJT). Referring to FIG. 2, it is illustrated that the switches are configured as BJTs, but the present invention is not limited thereto.

The main switching unit 110 of the power factor correction circuit 100 may perform the switching operations to adjust a phase difference between a voltage and a current of the input power, thereby improving a power factor thereof, and in this case, the auxiliary switching unit 120 may form transmission paths for surplus power remaining after the switching operation of the main switching unit 110.

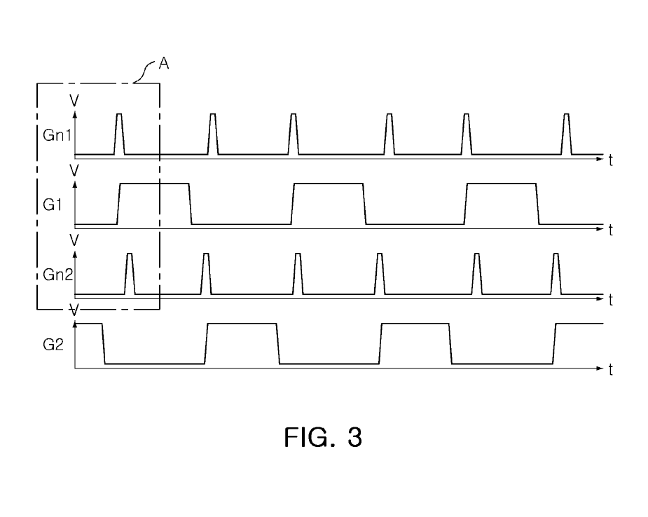

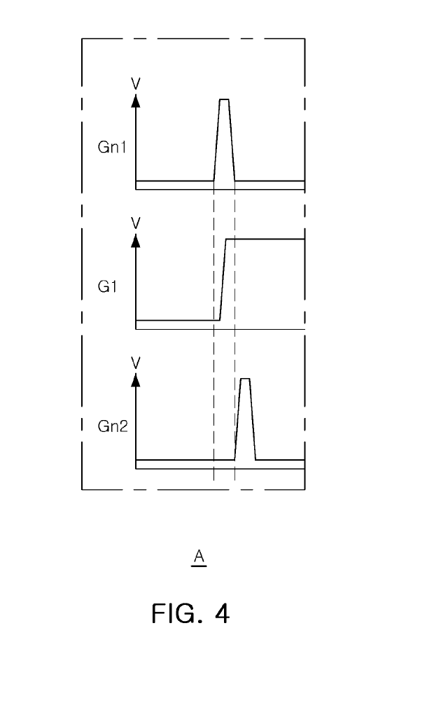

FIG. 3 is a graph showing switching control signals of the main switching unit 110 and the auxiliary switching unit 120 employed in the power factor correction circuit 100 according to the embodiment of the present invention, and FIG. 4 is an enlarged view of portion A of the graph of FIG. 3.

Referring to FIGS. 1, 3, and 4, the auxiliary switching unit 120 of the power factor correction circuit 100 according to the embodiment of the present invention may form the transmission paths for surplus power before the main switching unit 110 is turned on. Namely, in other words, switching loss may be eliminated with the provision of a zero-voltage switching condition.

In order to form the transmission paths for surplus power, the controller 150 may provide the switching control signals G1, G2, Gn1, and Gn2 for turning the auxiliary switching unit 120 on before the main switching unit 110 is turned on. When the switching control signals are high level signals, the respective switches S1, S2, Sn1, and Sn2 may be turned on, while when the switching control signals are low level signals, the respective switches S1, S2, Sn1, and Sn2 may be turned off.

In detail, the first auxiliary switch Sn1 may form the transmission path for surplus power existing before the first main switch S1 is turned on, and the second auxiliary switch Sn2 may form the transmission path for surplus power existing before the second main switch S2 is turned on.

To this end, as illustrated in FIGS. 3 and 4, the first auxiliary switch Sn1 is turned on before the first main switch S1 is turned on, and may be turned off before the first main switch S1 is turned off. This may be indicated as a first switching operation.

Also, the second auxiliary switch Sn2 may be turned on before the second main switch S2 is turned on, and may be turned off before the second main switch S2 is turned off. This may be indicated as a second switching operation.

In this case, the first switching operation and the second switching operation may have equal turn on intervals.

Meanwhile, the auxiliary switching unit 120 forms the transmission paths for surplus power of the main switching unit 110, whereby switching loss in the main switching unit 110 may be reduced; however, the auxiliary switching unit 120 may have switching loss.

In other words, a peak voltage due to excessive power may be generated at both ends of the auxiliary switching unit 120 at a time at which the auxiliary switching unit 120 is turned off, causing switching loss.

Thus, in order to solve the defect, referring to FIG. 1, the power factor correction circuit may further include the auxiliary inductor Ls for adjusting an amount of current flowing in the auxiliary switching unit 120 when the auxiliary switching unit 120 performs the switching operation. FIG. 1 illustrates a case in which the auxiliary inductor Ls is singularly provided and connected between a connection node of the first auxiliary switch Sn1 and the second auxiliary switch Sn2 and a ground, but the present invention is not limited thereto, and two auxiliary inductors may be configured in such a manner that one auxiliary inductor is connected between the first auxiliary switch Sn1 and the ground and the other auxiliary inductor is connected between the second auxiliary switch Sn2 and the ground.

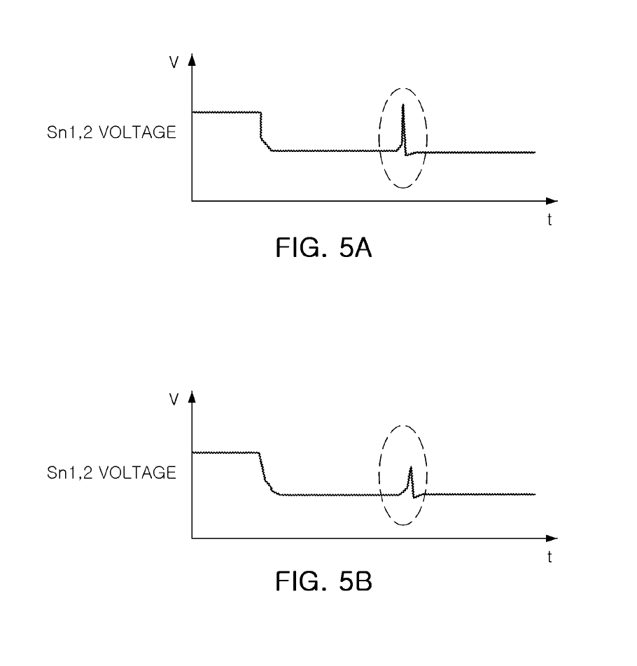

FIG. 5A and FIG. 5B are graphs showing voltages generated from the both ends of the auxiliary switching unit 120 employed in the power factor correction circuit according to the embodiment of the present invention. In FIG. 5A, a portion indicated by the dotted line is a peak voltage generated when the first auxiliary switch Sn1 and the second auxiliary switch Sn2 perform the first switching operation and the second switching operation, respectively.

In order to reduce the peak voltage, referring to FIG. 3, the first auxiliary switch Sn1 may perform a switching operation when the second switching operation is terminated, in order to form a transmission path for excessive power applied to the second auxiliary switch Sn2. Since the first auxiliary switch Sn1 performs the switching operation at a time at which the second switching operation of the second auxiliary switch Sn2 is terminated, a freewheeling path is formed so that the second auxiliary switch Sn2 may perform a soft turn-off operation. When the first switch performs the switching operation when the second switching operation of the second switch is terminated, a freewheeling path denoted by Sn2-Ls-DI1-Sn1-Ls is formed, and when the second switch performs a switching operation when the first switching operation of the first switch is terminated, a freewheeling path denoted by Sn1-Ls-DI2-Sn2-Ls is formed.

In this case, the switching operations of the first auxiliary switch Sn1 and the second auxiliary switch Sn2 for forming the freewheeling paths may be set to have turn on intervals equal to those of the second switching operation and the first switching operation, respectively.

FIG. 5B is a graph showing a voltage generated from both ends of the auxiliary switching unit 120 when the power factor correction circuit forms the freewheeling path. In comparison to the peak voltage of FIG. 5A, it can be seen that the peak voltage of FIG. 5B is reduced.

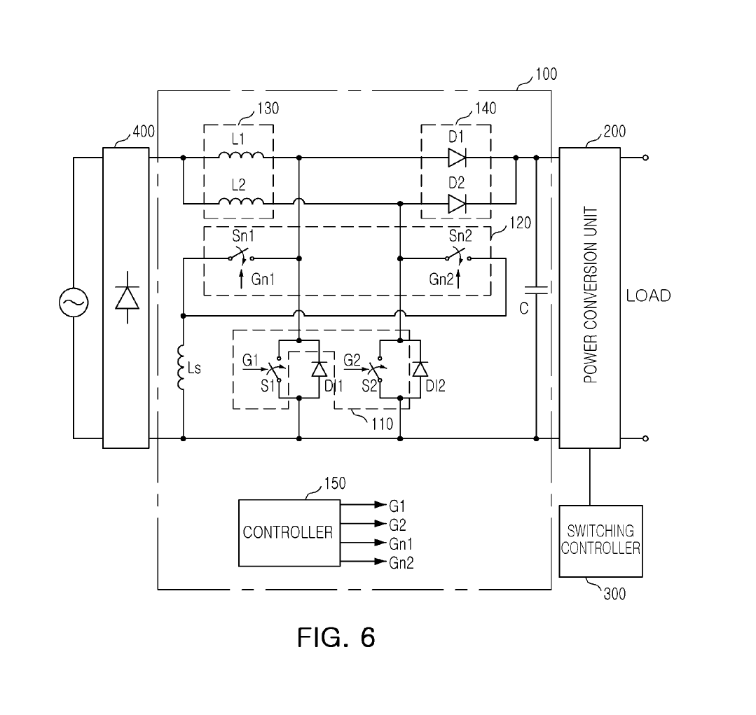

FIG. 6 is a view schematically showing a configuration of a power supply device including a power factor correction circuit according to an embodiment of the present invention.

Referring to FIG. 6, the power supply device may include the power factor correction circuit 100, a power conversion unit 200, a switching controller 300, and a rectifying unit 400.

The power factor correction circuit 100 is the same as the power factor correction circuit 100 illustrated in FIG. 1, so a detailed description thereof will be omitted.

Also, each of the first main switch S1, the second main switch S2, the first auxiliary switch Sn1, and the second auxiliary switch Sn2 of the power factor correction circuit 100 may an IGBT (Insulated gate bipolar transistor), a MOS-FET (metal oxide semiconductor field-effect transistor), or a BJT (bipolar junction transistor).

The power conversion unit 200 may switch DC power from the power factor correction circuit 100 to convert the power from the power factor correction circuit into DC power having a pre-set voltage level and supply the converted DC power to a load. The switching controller 300 may control the switching of the power conversion unit 200 according to a voltage or current level of the output DC power. The rectifying unit 400 may rectify AC power to generate input power and transfer the input power to the power factor correction circuit 100.

As set forth above, according to embodiments of the invention, a power factor correction circuit capable of reducing switching loss generated during switching for power factor correction by transferring surplus power to a ground before performing the switching for power factor correction, and removing a peak voltage generated when the surplus power is transferred to the ground, and a power supply device including the same can be provided.

While the present invention has been shown and described in connection with the embodiments, it will be apparent to those skilled in the art that modifications and variations can be made without departing from the spirit and scope of the invention as defined by the appended claims.

What is claimed is:

1. A power factor correction circuit comprising:
a main switching unit including a first main switch and a second main switch performing switching operations with a phase difference of 180 degrees therebetween, in order to improve a power factor of input power;
an auxiliary switching unit including a first auxiliary switch and a second auxiliary switch forming transmission paths for surplus power existing before the first main switch and the second main switch are turned on, respectively;
an inductor unit positioned between an input power terminal to which the input power is applied and the main switching unit and storing or discharging power according to the switching operations of the main switching unit; and
an auxiliary inductor adjusting an amount of current flowing in the auxiliary switching unit when the auxiliary switching unit performs switching operations.

2. The power factor correction circuit of claim 1, wherein the first auxiliary switch performs a first switching operation of being turned on before the first main switch is turned on, and turned off before the first main switch is turned off, and
the second auxiliary switch performs a second switching operation of being turned on before the second main switch is turned on, and turned off before the second main switch is turned off.

3. The power factor correction circuit of claim 2, wherein the first switching operation and the second switching operation have equal turn on intervals.

4. The power factor correction circuit of claim 1, further comprising a first backward current preventing diode and a second backward current preventing diode preventing backward currents in the first main switch and the second main switch, respectively.

5. The power factor correction circuit of claim 2, wherein the first auxiliary switch performs a switching operation to form a transmission path for excessive power applied to the second auxiliary switch when the second switching operation is terminated, and
the second auxiliary switch performs a switching operation to form a transmission path for excessive power applied to the first auxiliary switch when the first switching operation is terminated.

6. The power factor correction circuit of claim 5, wherein the first auxiliary switch performs the switching operation at a time at which the second switching operation is terminated, and the second auxiliary switch performs the switching operation at a time at which the first switching operation is terminated.

7. The power factor correction circuit of claim 6, wherein the first auxiliary switch is turned on during an interval identical to a turn on interval of the second switching operation at the time at which the second switching operation is terminated, and
the second auxiliary switch is turned on during an interval identical to a turn on interval of the first switching operation at the time at which the first switching operation is terminated.

8. The power factor correction circuit of claim 1, further comprising a diode unit providing transmission paths for the power discharged from the inductor unit according to the switching operations of the main switching unit.

9. The power factor correction circuit of claim 8, wherein the inductor unit includes:
a first inductor connected between the input power terminal and the first main switch; and
a second inductor connected between the input power terminal and the second main switch.

10. The power factor correction circuit of claim 9, wherein the diode unit includes:
a first diode providing the transmission path for the power discharged from the first inductor according to the switching operation of the first main switch; and
a second diode providing the transmission path for the power discharged from the second inductor according to the switching operation of the second main switch.

11. The power factor correction circuit of claim 8, further comprising a capacitor stabilizing the power transferred from the diode unit thereto.

12. The power factor correction circuit of claim 1, further comprising a controller providing switching control signals for controlling the switching operations of the main switching unit and the auxiliary switching unit.

13. The power factor correction circuit of claim 1, wherein the input power is rectified power.

14. A power supply device comprising:
power factor correction circuit including a main switching unit including a first main switch and a second main switch performing switching operations with a phase difference of 180 degrees therebetween, in order to improve a power factor of input power; an auxiliary switching unit including a first auxiliary switch and a second auxiliary switch forming transmission paths for surplus power existing before the first main switch and the second main switch are turned on, respectively; an inductor unit positioned between an input power terminal to which the input power is applied and the main switching unit and storing or discharging power according to the switching operations of the main switching unit; and an auxiliary inductor adjusting an amount of current flowing in the auxiliary switching unit when the auxiliary switching unit performs switching operations;
a power conversion unit switching the power from the power factor correction circuit to convert the power from the power factor correction circuit into power having a pre-set level; and
a switching controller controlling the switching of the power performed by the power conversion unit.

15. The power supply device of claim 14, wherein the first auxiliary switch performs a first switching operation of being turned on before the first main switch is turned on, and turned off before the first main switch is turned off, and
the second auxiliary switch performs a second switching operation of being turned on before the second main switch is turned on, and turned off before the second main switch is turned off.

16. The power supply device of claim 15, wherein the first switching operation and the second switching operation have equal turn on intervals.

17. The power supply device of claim 14, wherein the power factor correction circuit further includes a first backward current preventing diode and a second backward current preventing diode preventing backward currents in the first main switch and the second main switch, respectively.

18. The power supply device of claim 15, wherein the first auxiliary switch performs a switching operation to form a transmission path for excessive power applied to the second auxiliary switch when the second switching operation is terminated, and
the second auxiliary switch performs a switching operation to form a transmission path for excessive power applied to the first auxiliary switch when the first switching operation is terminated.

19. The power supply device of claim 18, wherein the first auxiliary switch performs the switching operation at a time at which the second switching operation is terminated, and the second auxiliary switch performs the switching operation at a time at which the first switching operation is terminated.

20. The power supply device of claim 19, wherein the first auxiliary switch is turned on during an interval identical to a turn on interval of the second switching operation at the time at which the second switching operation is terminated, and
the second auxiliary switch is turned on during an interval identical to a turn on interval of the first switching operation at the time at which the first switching operation is terminated.

21. The power supply device of claim 16, wherein the power factor correction circuit further includes a diode unit providing transmission paths for the power discharged from the inductor unit according to the switching operations of the main switching unit.

22. The power supply device of claim 21, wherein the inductor unit includes:
a first inductor connected between the input power terminal and the first main switch; and
a second inductor connected between the input power terminal and the second main switch.

23. The power supply device of claim 22, wherein the diode unit includes:
a first diode providing the transmission path for the power discharged from the first inductor according to the switching operation of the first main switch; and
a second diode providing the transmission path for the power discharged from the second inductor according to the switching operation of the second main switch.

24. The power supply device of claim 21, wherein the power factor correction circuit further comprises a capacitor stabilizing the power transferred from the diode unit thereto.

25. The power supply device of claim 14, wherein the power factor correction circuit further includes a controller providing switching control signals for controlling the switching operations of the main switching unit and the auxiliary switching unit.

26. The power supply device of claim 14, further comprising a rectifying unit rectifying alternating current (AC) power to generate the input power, and transferring the input power to the power factor correction circuit.
